(19) United States
(12) Patent Application Publication
(10) Pub. No.: US 2002/0059070 A1
(43) Pub. Date: May 16, 2002

(54) Itinerary creating apparatus and itinerary creating service system

(75) Inventor: Masaki Watanabe, Kanagawa-ken (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 09/984,548

(22) Filed: Oct. 30, 2001

(30) Foreign Application Priority Data
Nov. 13, 2000 (JP) P2000-345488

(51) Int. Cl. G10L 15/18

(52) U.S. Cl. 704/257

(57) ABSTRACT

A language analyzer converts an instruction sentence entered by an operator is converted into a speech frame. Based on this speech frame, a central control unit creates an itinerary, and visiting spots, a route between the visiting spots and a visiting day representing the created itinerary are stored respectively as a node, a link and a schedule in a state variable holding device. In addition, a node, a link and a schedule entered/searched in the past are stored in the state variable holding device. A currently targeted node is specified, and then the central control unit recreates an itinerary by focusing only on a node, a link and a schedule related to the currently targeted node, stored in the state variable holding device.

### BACKGROUND OF THE INVENTION

1. Field of the Invention

The present invention relates to an itinerary creating apparatus capable of making changes/additions to an already-created itinerary, and an itinerary creating service system.

2. Description of Related Art

As a conventional itinerary creating service system, a technology described in International Patent Application Laid-Open No. WO96/17315 has been known.

According to this conventional technology, by entering only rough conditions, a schedule for visiting a plurality of spots (facilities, shops, sightseeing spots, places of accommodations, returning places, and so on) was made, and presented to a user. Thus, for example, if an operator enters the condition of “two people want to have a one-day tour of Tokyo Bay Area within 10 thousand yen by car irrespective of the time of returning home”, the itinerary creating apparatus of this conventional technology suggests, to the operator, a basic frame of the order of “start→strolling→lunch→amusement park→night view→return home”. If the operator agrees with it, specific facilities are searched based on the basic frame, and an itinerary, i.e., “Yamashita Park” for strolling, “*** Restaurant in China Town” for lunch, “Disneyland” for an amusement park, and “Yokohama Bay Bridge” for night view, is presented.

### SUMMARY OF THE INVENTION

However, in a conventional itinerary creating service system, a basic frame was decided based on an entered schedule, and then specific facilities based on the basic frame were searched in order. Thus, when a need arose to change a part of a lastly presented specific itinerary, such a change was impossible. Consequently, the conditions had to be entered all over again, which led to a loss of high convenience for any operator.

An object of the invention is to provide an itinerary creating apparatus capable of making changes/additions to an already-created itinerary, and an itinerary creating service system.

In order to achieve the foregoing object, in accordance with an first aspect of the invention, provided is an itinerary creating apparatus comprising: a language analyzer configured to convert an instruction sentence entered by an operator into a speech frame; an itinerary creating device configured to create an itinerary based on the speech frame obtained by the conversion of the instruction sentence by the language analyzer; an itinerary storage unit configured to store visiting spots, a route between the visiting spots and a visiting day representing the itinerary created by the itinerary creating device respectively as a node, a link and a schedule, and also storing a node, a link and a schedule entered/searched in the past; a node specification unit configured to specify a currently targeted node, and an itinerary re-creating device configured to re-create an itinerary by focusing only on a node, a link and a schedule related to the currently targeted node, stored in the itinerary storage unit.

According to the foregoing configuration, an instruction sentence entered by the operator is converted into a speech frame, an itinerary is created based on the speech frame, visiting spots, a route between the visiting spots and a visiting day representing the created itinerary are respectively stored as a node, a link and a schedule, a node, a link and a schedule entered/searched in the past are also stored, a currently targeted node is specified, and then an itinerary is re-created by focusing only on a node, a link and a schedule related to the stored currently targeted node. Thus, without re-creating all the plans, it is possible to make changes/additions to an already-created itinerary, contributing to the enhancement of convenience.

### BRIEF DESCRIPTION OF THE DRAWINGS

FIG. 1 is a schematic configuration view of a first embodiment of the present invention.

FIG. 2 is a view showing a speech frame structure for various input instruction sentences.

FIG. 3 is a view showing a data structure for representing an itinerary.

FIG. 4 is a view showing an example of processing rules for carrying out itinerary creating.

FIG. 5 is a flowchart showing a process of itinerary creating.

FIG. 6 is a view schematically showing an example of processing for temporary saving and recovery of information.

FIG. 7 is a view showing an example of a response sentence corresponding to an itinerary creating situation.

FIG. 8 is a view showing an example of screen displaying according to the present embodiment.

FIG. 9 is a schematic configuration view of a second embodiment of the present invention.

### DESCRIPTION OF THE PREFERRED EMBODIMENTS

Next, the preferred embodiments of the present invention will be described with reference to the accompanying drawings.

### First Embodiment

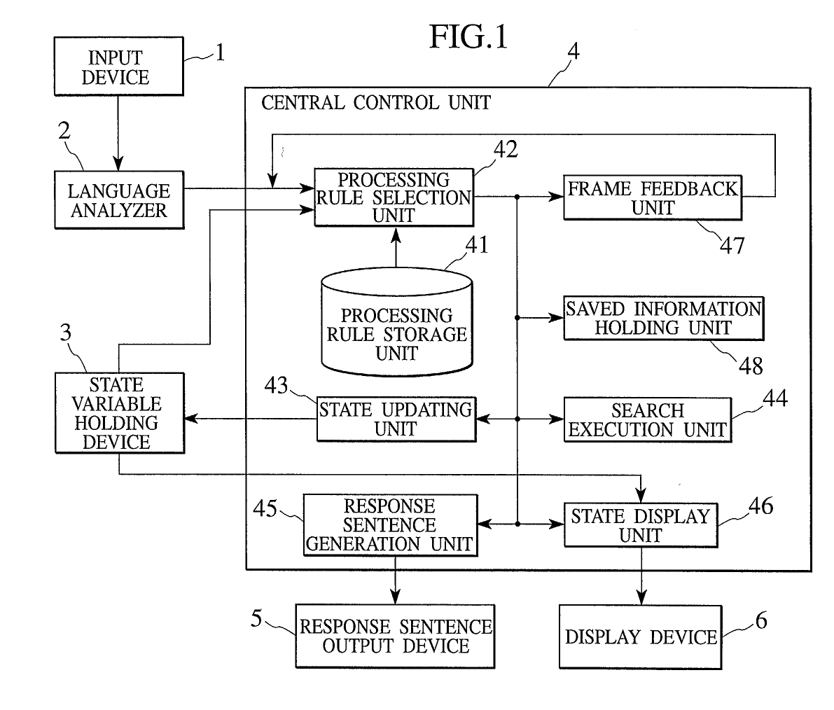

FIG. 1 is a view showing the configuration of an itinerary creating service system according to the first embodiment of present the invention.

First, the system configuration will be described. This system comprises: an input device 1 for entering an instruction sentence regarding itinerary creating in the form of a natural language; a language analyzer 2 for converting an instruction content obtained by subjecting the entered instruction sentence to natural language analysis to an internal representation called a speech frame; a state variable holding device (itinerary storage unit) (node specifying unit) 3 for holding the content of an itinerary under creation and a system internal state as state variables; a central control unit 4 (itinerary creating device) (itinerary re-creating device) for executing itinerary creating processing based on the supplied speech frame and the state variables; a response sentence output device 5 for outputting a response sentence from the system to a user; and a display device 6 for presenting to a user the content of the itinerary under creation and the system internal state, held in the state variable holding device 3, in a direct or processed form.

Next, detailed description will be made of each unit configuring the system.

The input device 1 may be a sound concentrating device including a microphone for entering an instruction sentence by voice, or a character input device including a keyboard for entering a text by characters. In the case of the character input device, it is not necessary to operate a personal computer for menu selection or the like, and for example, if a handwriting character input function is added, even a general user can easily enter an instruction sentence.

The response output device 5 may be a voice output device including a speaker for outputting a response sentence by voice, or constituted to be united with the display device 6 for outputting the text of a response sentence. The display device 6 is a display including a liquid crystal monitor or a CRT.

The language analyzer 2, the state variable holding device 3 and the central control unit 4 constitute an information processor composed of a CPU, a ROM, a RAM and others, and may constitute an integrated computer.

If an instruction sentence is supplied by voice from the input device 1, the language analyzer 2 first subjects the instruction sentence to voice analysis processing, performs a series of natural language analysis processing including morphological analysis, syntactic analysis, semantic analysis, and so on, and then converts the instruction content of the user into a speech frame by referring to the meaning of the analyzed instruction sentence. The speech frame is composed of an instruction class and an instruction prescribed value, and it is an internal representation of the instruction content intended by the user. The instruction class may be considered to be a function thereof, and the instruction prescribed value an argument thereof.

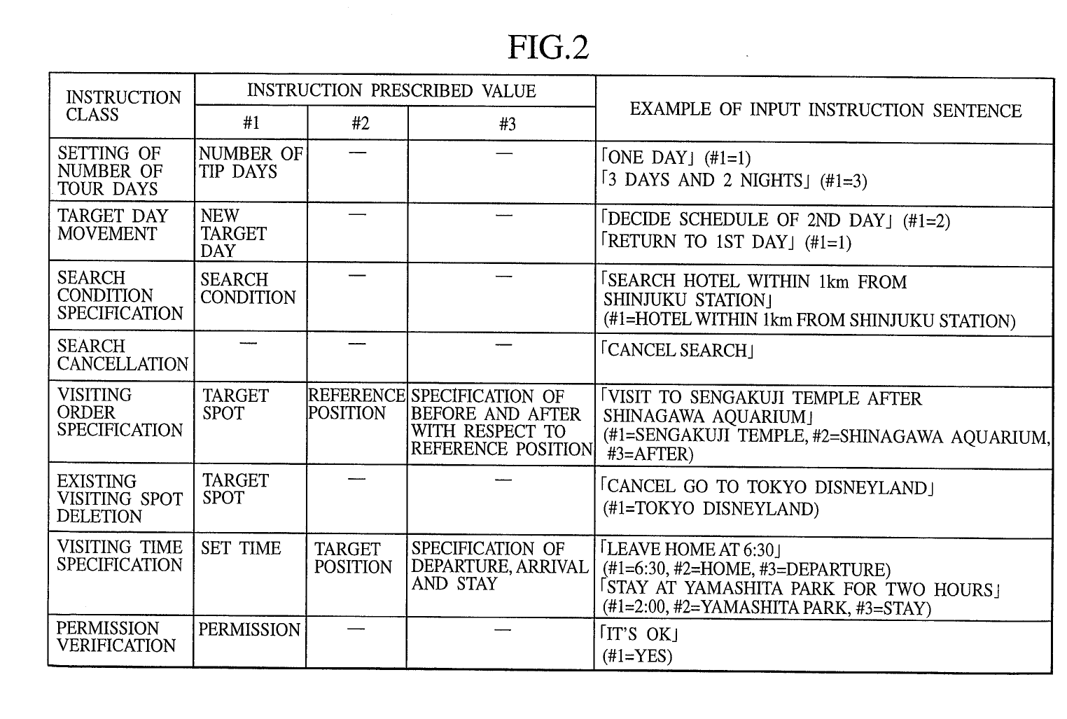

As shown in FIG. 2, the embodiment permits the entry of roughly eight-divided instruction classes, i.e., setting of the number of tour days, target day movement, specification of a search condition, search interruption, specification of visiting order, deletion of the existing visiting spot specification of visiting time, and permission verification.

For example, for an instruction sentence such as “DECIDE SCHEDULE OF 2ND DAY” or “RETURN TO FIRST DAY”, “TARGET DAY MOVEMENT” is extracted as an instruction class for any of such sentences, and a new target day “2ND”, or “1ST” after the movement is extracted as an instruction prescribed value, thus constituting a speech frame.

For an instruction sentence “VISIT TO SENGAKUJI TEMPLE AFTER SHINAGAWA AQUARIUM” or the like, “SPECIFICATION OF VISITING ORDER” is set as an instruction class, and three values, i.e., “SENGAKUJI TEMPLE” as a target spot of order specification, “SHINAGAWA AQUARIUM” as a reference position, and “NEXT (SUBSEQUENT)” indicating a specification order before/after the reference position, are set as instruction prescribed values, thus constituting a speech frame.

Thus, the number of instruction prescribed values is not limited to one, and set in accordance with an instruction class. In addition, if an instruction class is “SPECIFICATION OF SEARCH CONDITION”, then as shown in FIG. 2, an instruction prescribed value itself is used as a search condition, e.g., “HOTEL WITHIN 1 KM OF SHINJUKU STATION”. This is obtained in a manner that the language analyzer 2 extracts a spot search condition from the instruction sentence, and this condition is converted into structured data composed of a search condition class (search function) such as spot attributed specification, inter-spot distance specification or the like, and a search condition prescribed value (argument) such as specified attribute “HOTEL”, a distance specified reference spot=“SHINJUKU STATION”, a specified distance=“2 KM”. The structured data will be referred to as a search condition frame, hereinafter.

For the specification of search conditions, search may be continued while the user narrows down or relaxes conditions by a plurality of instruction entries for one search item. For example, after the end of a round of searching for a speech, “FIND HOTEL WITHIN 1 KM FROM SHINJUKU STATION”, another condition, e.g., “ALONG MEIJI STREET?” may be added, or distance limitation may be relaxed by asking “WITHIN 2 KM?”. In such a case, it is the hotel specified in the previous speech that the user searches and, if the condition of the previous speech is ignored, then no search is possible to satisfy the intention of the user. Thus, if a search condition specification sentence is continuously entered, the structured data called a search condition frame is set as an instruction prescribed value of the speech frame such that new conditions can be properly added/updated/deleted for the search condition of the previous speech.

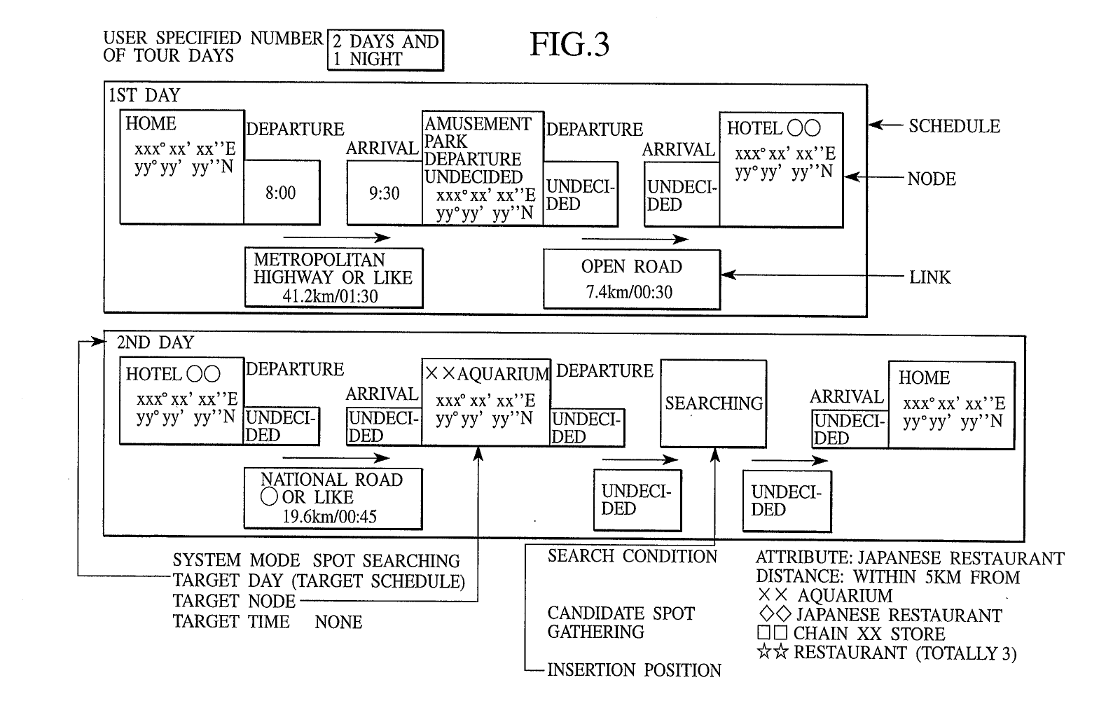

The state variable holding device 3 temporarily stores and holds the content of an itinerary under creation, and the internal state of the system. The itinerary in this case is basically a series of visiting spots along a time axis, for example, one stored in the form of FIG. 3. Each visiting spot is represented by structured data called “NODE”, and the name, position, arrival and departure time, and so on, of the visiting spot are held. One day itinerary is represented by data called “SCHEDULE”. The schedule is an indefinite length list of a node, and the visiting order of spots is represented by the arraying order of nodes in the list. Another data called “LINK” is provided to represent a route, a distance and the required time between two visiting spots.

The entire itinerary is represented by an indefinite length list containing schedules as elements. At the end of itinerary creating, the number of held schedules indicates the number of tour days. However, in the middle of the itinerary creating, it is not always the case that schedules equivalent to the number of tour days specified by the user are held. Thus, another data for holding “USER SPECIFIED NUMBER OF DAYS” is provided.

Regarding the internal state of the system, there is a “SYSTEM MODE” indicating a current system operation state such as on-going spot searching, standing-by for general instruction entry, standing-by for permission response from the user or the like. Especially, there are parameters including: “SEARCH CONDITION” entered thus far and “COLLECTION OF CANDIDATE SPOTS” thus narrowed down during spot searching; “INSERTION POSITION” in a schedule for inserting a currently searched spot; “TARGET DAY (TARGET SCHEDULE)” indicating the day to be currently operated by the system when tour days are plural; “TARGET NODE” indicating a node to be operated in the target day; “TARGET TIME” indicating time especially when departure or arrival time of a given node is to be entered; and others. These parameters are also shown with the itinerary in FIG. 3. The itinerary content and the system internal state are collectively called state variables.

Returning to FIG. 1, the central control unit 4 is shown to be constituted of: a processing rule storage unit 41 for prestoring all the conditions for enabling the specified prescribed value of a speech fame and an information variable value held by the state variable holding device 3 to be combined for each instruction class of a speech frame, and itinerary creating processing to be executed when conditions are satisfied, as processing rules, in an all-inclusive manner; a processing rule selection unit 42 for selecting itinerary creating processing to be executed from the processing rule storage unit 41 based on the content of an entered speech frame, and the value of a state variable at this time; a state updating unit 43 for updating a state variable in accordance with the selected processing rule; a search execution unit 44 for executing search of a visiting spot or the like in accordance with the selected processing rule; a response sentence generation unit 45 for generating a response sentence in accordance with the selected processing rule; a state display unit 46 for preparing the displaying of a state variable in accordance with the selected processing rule; a frame feedback unit 47 for generating a pseudo speech frame and feeding back the speech frame to the processing rule selection unit 42; and a saved information holding unit 48 for temporarily saving an instruction content and a necessary system state.

The content of itinerary creating processing executed by the central control unit 4 is pre-described in the form of a processing rule in the processing rule storage unit 41. In this case, the processing rule lists up all the conditions for enabling, for each instruction class of a speech frame, an instruction prescribed value as its argument part and the value of a state variable held by the state variable holding device 3 to be combined, and appends the content of processing to be executed by the central control unit 4 for each condition when each condition is satisfied.

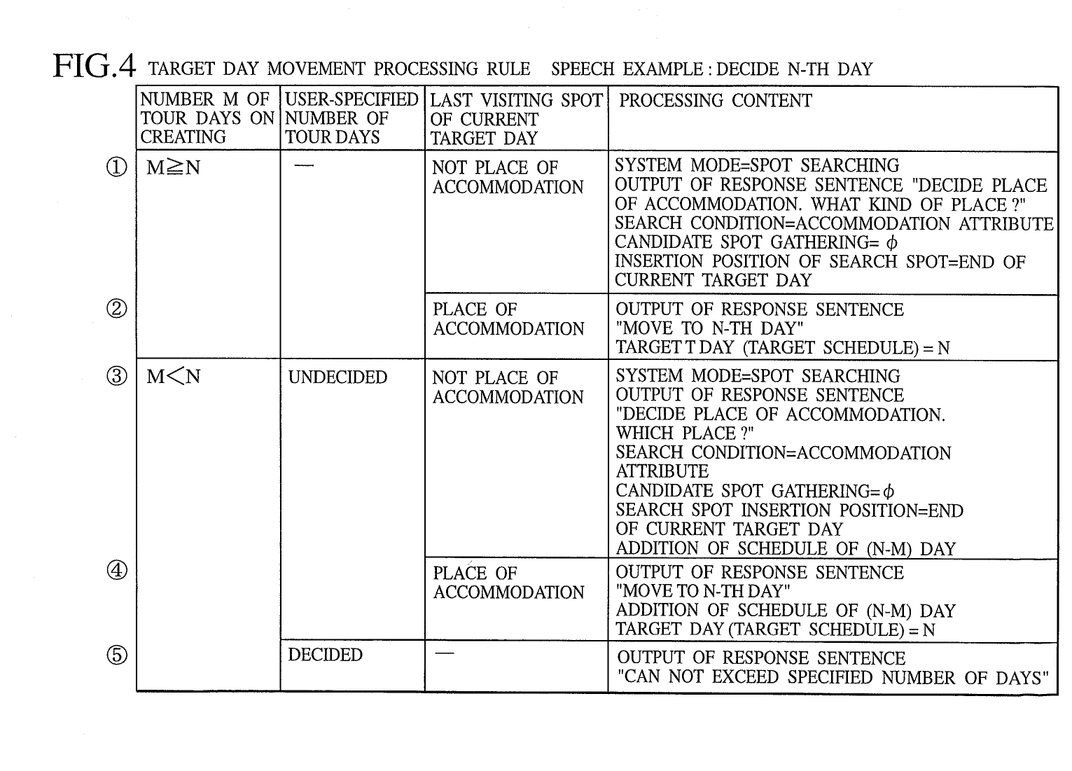

For example, FIG. 4 shows a processing rule when an instruction class of a speech frame is “TARGET DAY MOVEMENT”. In this case, assuming that a new target day as an instruction prescribed value is N (th) day and schedules of M days have already been prepared in an itinerary under creation, firstly processing to be executed is largely divided into two parts depending on the relation of size between M and N.

If the target day N, on which the user plans to move, is within the range of the already set number of days, as shown in (2) of FIG. 4, basically a movement can be made on the N-th day, and a schedule of this day can be made.

However, it is recommended that when a day schedule is moved, a place of accommodation should be decided for a currently targeted day. For example, when a first day schedule is made, and then a second day schedule is decided, if the last place of accommodation of the first day has been decided, then schedule making is conveniently executed with this as a first starting place of the second day. Thus, for the currently targeted day before the movement of a day schedule, as shown in (1) of FIG. 4, if a last visiting spot is not a place of accommodation such as a hotel, first, to decide the place of accommodation for the currently targeted day, preparation is made to transfer to spot search processing.

On the other hand, when a target day is moved exceeding the number of days currently on creating (M<N), if the user has already specified the number of tour days, e.g., “3 DAYS AND 2 NIGHTS”, as shown in (5) of FIG. 4, an instruction, “DECIDE 4TH DAY”, exceeding the above is not permitted.

However, though schedules of 3 days have been made at present, as shown in (3) and (4) of FIG. 4, if there has been no specification made of “3 DAYS”, then movement to 4th day is permitted. In this case, as in the cases of (1) and (2) of FIG. 4, processing is divided depending on whether there is a last place of accommodation or not for a target day before moving. In addition, different from (1) and (2) of FIG. 4, a schedule of (N-M) days as a shortage is added.

Thus, since processing to be executed at that time had been decided for all the possible cases for one instruction class, the system can deal with any arbitrary instruction given at arbitrary time. The processing rule selection unit 42 selects a processing rule for satisfying a condition part based on the content of the supplied speech frame, and the value of a state variable at this time. Then, in accordance with the selected rule, at least one or more of the units 43 to 48 are actuated, and the corresponding processing is executed.

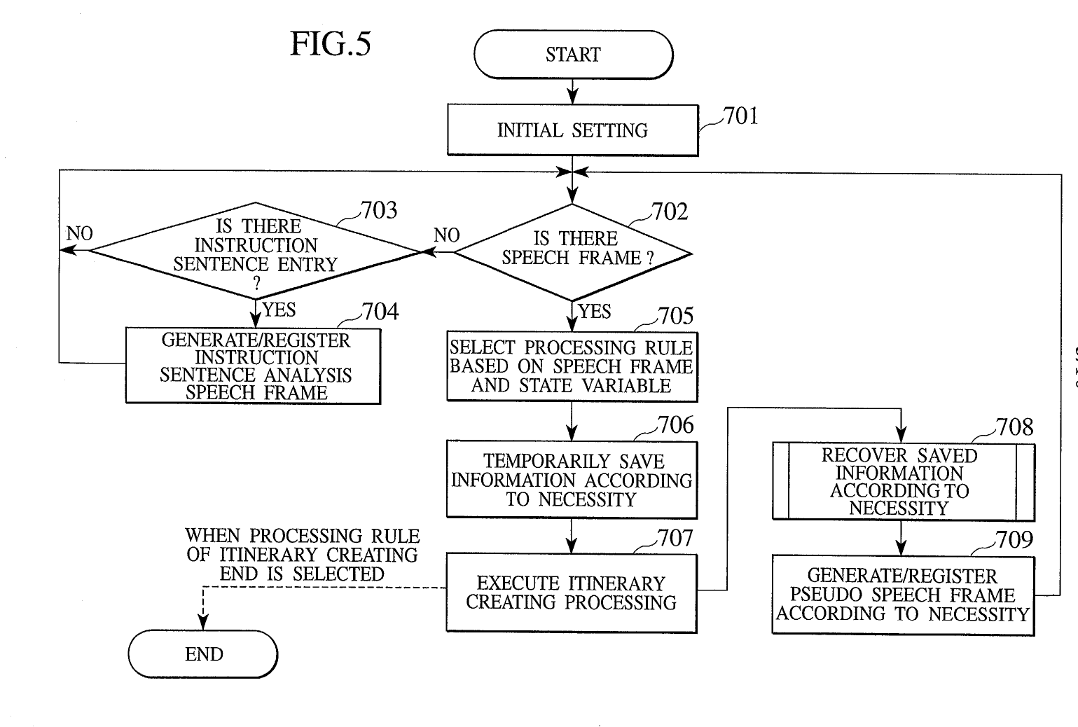

Next, the basic operation of the system will be described by referring to a flowchart shown in FIG. 5.

First, in step S701, the system is subjected to initialization setting. For an itinerary, a schedule of only one day equivalent to the first day of a tour is prepared, and the home of the user pre-registered in the first node thereof is set. A target schedule is the first day, and its target node is the home. A system mode is set to be “STANDBY FOR GENERAL INSTRUCTION ENTRY”, and other state variables are all set to be indefinite values.

Then, in step S702, the central control unit 4 checks to determine whether a speech frame to be processed exists or not. It is assumed that speech frames have been registered in a queue called a speech frame queue based on the generation order as a result of the analysis and conversion of an entered itinerary creating instruction sentence by the language analyzer 2. Pseudo speech frames generated inside the central control unit 4 may also be registered in the queue. The central control unit 4 checks the content of the speech frame queue and, if there are no registered speech frame, the process proceeds to step S703. Needless to say, in the initial system state, the queue is empty.

In step S703, investigation is made as to the entry of an instruction sentence to be processed by the language analyzer 2. It is assumed here that an instruction sentence regarding itinerary creating entered through the input device 1 by the user has been registered in the queue as in the case of the speech frames. If there is an instruction sentence to be processed therein, the process proceeds to step S704. If the queue of instruction sentences to be processed is empty, the process returns to step S702. Thus, if no instruction sentence is entered, and no speech frame has been registered, loop processing is repeated between steps S702 and S703, and the process is placed on standby for the entry of an instruction sentence from the user.

In step S704, the language analyzer 2 analyzes the entered instruction sentence, and generates and registers a speech frame in the speech frame queue. In this processing, as described above, determination is made as to which of the eight instruction classes shown in FIG. 2 the supplied instruction sentence belongs to. Then, an instruction prescribed value is extracted for each instruction class, and the instruction content is converted into an established form called a speech frame.

For example, an instruction sentence of “2 DAYS AND 1 NIGHT” is understood to belong to “SETTING OF NUMBER OF TOUR DAYS” among the eight instruction classes, because it is composed of only numerals and keywords such as “DAY” and “NIGHT”. In the setting of the number of tour days, since an instruction prescribed value is only one of “NUMBER OF TOUR DAYS”, and because of the combination of “2” and “DAYS” in the instruction sentence, a speech frame of “INSTRUCTION CLASS=SETTING OF NUMBER OF TOUR DAYS, NUMBER OF TOUR DAYS=2” is generated.

In the case of an instruction sentence, “WISHING TO VISIT ZOO IN YOKOHAMA CITY”, the part of “ZOO IN YOKOHAMA CITY” is understood to constitute a search condition frame of “(SEARCH CONDITION CLASS=SPOT ADDRESS SPECIFICATION, SPECIFIED ADDRESS=YOKOHAMA CITY), and (SEARCH CONDITION CLASS=SPOT ATTRIBUTE SPECIFICATION, SPECIFIED ATTRIBUTE=ZOO)”. Thus, a speech frame of “INSTRUCTION CLASS=SEARCH CONDITION SPECIFICATION, SEARCH CONDITION=ABOVE SEARCH CONDITION FRAME” is generated. In this case, “WISHING TO VISIT” in the instruction sentence complementarily indicates the intention of the user if a given spot is decided as a visiting spot. However, it is after all a request for searching a visiting spot to be decided, and not contradictory to the understanding of other parts, giving no direct influence to the structure of the speech frame. Accordingly, even when simply “ZOO IN YOKOHAMA CITY” or “SEARCH ZOO IN YOKOHAMA CITY” is entered, a result is the generation of the completely same speech frame. In addition, if the previous speech is to instruct specification of a search condition, and a speech of specifying a search condition is continuously provided, a newly extracted search condition is added/updated for the search condition frame of the previous speech. For natural language processing such as morphological analysis, syntactic analysis and semantic analysis necessary for the above processing, the specialized/limited application of a generally known natural language processing method to the above-described processing is relatively easy.

Though not shown in FIG. 2, a speech frame for instructing special processing other than the foregoing may be generated. For example, for an instruction sentence of “RESET”, a speech frame of “INSTRUCTION CLASS=SPECIAL PROCESSING, INSTRUCTION PRESCRIBED VALUE=RESET” is generated, and in the itinerary creating of a subsequent stage, exceptional processing such as return to step S701 can be executed especially. In addition, for an instruction sentence impossible to be analyzed, which is equivalent to none shown in FIG. 2, a speech frame of “INSTRUCTION CLASS=SPECIAL PROCESSING, INSTRUCTION PRESCRIBED VALUE=ANALYSIS IMPOSSIBLE” is generated, and a response sentence indicating the impossible understanding of the intention of the user may be generated and outputted in the processing of the subsequent stage.

The language analyzer 2 returns the process to step S702 after the end of the generation of the speech frame and its registration in the speech frame queue. Immediately thereafter, since the queue is not empty, the process moves from step S702 to step S705. The processing of the language analyzer 2 in each of steps S703 and S704, may be executed simultaneously with the processing of the central control unit 4 in step S702 and step S705. In this case, both processing operations are associated with each other through a common data area called a speech frame queue.

In step S705, the processing rule selection unit 42 of the central control unit 4 takes out one speech frame to be processed from the speech frame queue, and selects a processing rule to satisfy a condition part based on the content of the selected speech frame while referring to a state variable value held in the state variable holding device 3.

Then, in step S706, if the selected processing rule includes temporarily saving processing description of a speech frame and a necessary state variable, the central control unit 4 saves necessary information in the saved information holding unit 48. This spot will be described in detail later.

In step S707, the central control unit 4 executes proper itinerary creating processing in accordance with the selected processing rule. The processing in this case includes the rewriting of a state variable such as an itinerary content, a system internal state or the like, the execution of data base search based on a given search condition, the synthesis of response sentences outputted to the user, data processing necessary for state variable displaying, and so on. Such processing is executed by each of the state updating unit 43, the search execution unit 44, the response sentence generation unit 45, and the state display unit 46 when necessary. Especially when a condition for finishing itinerary creating is set in, a rule for finishing the processing is selected in step S705, and thus the processing is finished in step S707.

Further, in step S708, if the selected processing rule includes the description of recovery of the saved speech frame and necessary state variable, then the central control unit 4 recovers the necessary information from the saved information holding unit 48. Now, the temporary saving and recovery of information will be described by way of example.

For example, in target day movement processing shown in FIG. 4, the process is moved to the search of a place of accommodation in the cases of (1) and (3), and a place of accommodation is decided in accordance with a search condition setting instruction from the user in a continuous manner.

In this state, however, a speech frame regarding the instruction of “DECIDE N-TH DAY”, first provided when the place of accommodation was decided, has been completely lost. Thus, to move a target day as originally intended, the user is required to provide a speech of “DECIDE N-TH DAY” again after the deciding of the place of accommodation.

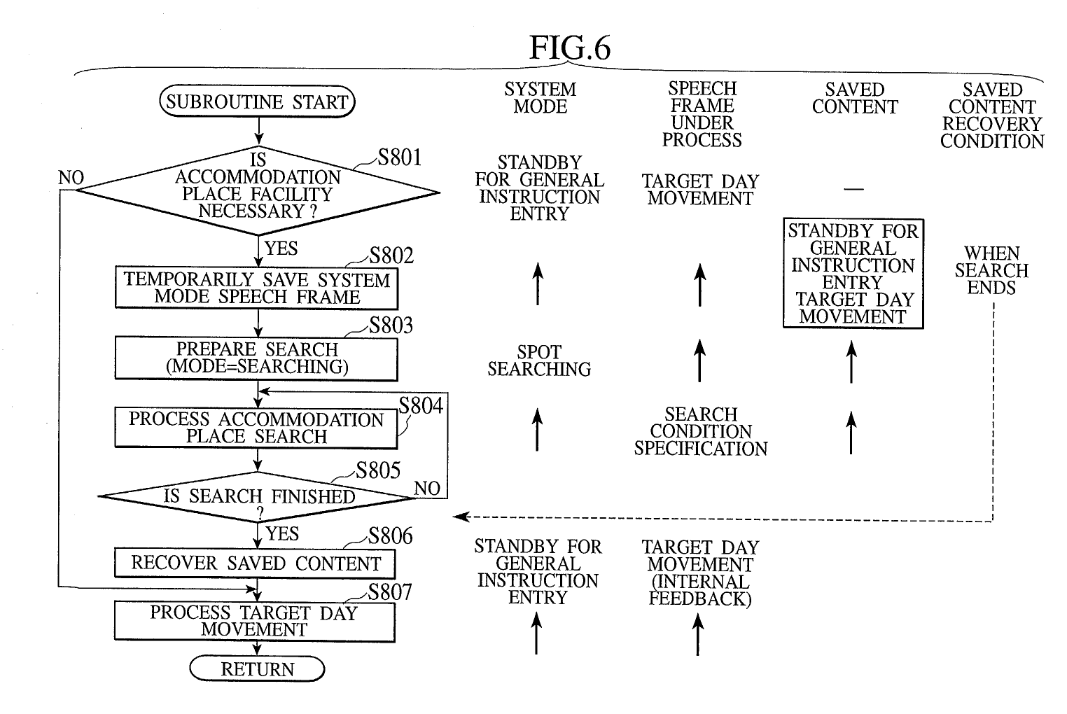

In practice, therefore, temporary saving of a speech frame and system mode is further included in the processing of (1) and (3). A typical flow of processing along this example is schematically shown in FIG. 6.

In a sub-routine shown in FIG. 6, in step S801, the system is in the middle of execution of target day movement processing, and determination is made as to the necessity of setting a place of accommodation. Specifically, this processing is equivalent to the processing rule selection processing of step S705 shown in FIG. 5, and determination is made as to its equivalency to (1) and (3) of the processing rule of FIG. 4. At a spot of this time, a system mode is “STANDBY FOR GENERAL INSTRUCTION ENTRY”, and the instruction class of a speech frame under processing is “TARGET DAY MOVEMENT”.

If the setting of a place of accommodation is necessary, the process proceeds to step S802. In the described example, the content of a target day movement instruction including the current system mode, i.e., “STANDBY FOR GENERAL INSTRUCTION ENTRY”, and the speech frame, i.e., “DECIDE N-TH DAY”, is saved in the saved information holding unit 48. As to when and in what case the saved information is recovered, a recovery condition of “WHEN SEARCH IS FINISHED” is stored as one of state variables held by the state variable holding device 3. The above processing is equivalent to that of step S706 shown in FIG. 5.

Then, in step S803, preparation for advancing the search of a place of accommodation, i.e., processing described in the processing rule of (1) and (3) of FIG. 4, is executed. In this case, the system mode is rewritten into “ON-GOING SPOT SEARCH”. This step is equivalent to step S707 shown in FIG. 5. In practice, since the processing is described, including the saving processing of step S802, in the processing rule of (1) and (3), steps S802 and S803 are executed in an order described in the processing rule, and thus it is not always the case that temporary saving processing and other processing are executed in a clearly divided manner.

When the foregoing processing is completed, the execution of target day movement processing is finished and, in the subsequent repetition of steps S804 and S805, the search processing of a place of accommodation is advanced in accordance with an instruction newly entered by the user. Basically, during this period, a system mode is “ON-GOING SPOT SEARCH”, and the instruction class of a speech frame to be processed is “SEARCH CONDITION SPECIFICATION”. After the establishment of a place of accommodation, search end processing described in another processing rule is executed. This processing rule is divided into “CASE WHERE SAVED INFORMATION RECOVERY CONDITION IS SEARCH END TIME” and “CASE WHERE SAVED INFORMATION RECOVERY CONDITION IS NOT SEARCH END TIME”, and only in the former case, saved information recovery processing is simultaneously executed. In this way, in step S806 following the search end of step S805, information held in the saved information holding unit 48 is recovered simultaneously with the original search end processing.

In the described case, based on the saved content, the system mode is updated to “STANDBY FOR GENERAL INSTRUCTION ENTRY”, and the speech frame of “DECIDE N-TH DAY”(TARGET DAY MOVEMENT) is sent to the frame recovery unit 47 of the central control unit 4, and registered in the above-described speech frame queue. Then, the saved content of the saved information holding unit 48 is cleared. These operations are equivalent to those of steps S707 to S709 shown in FIG. 5.

In subsequent step, the speech frame registered in the queue is continuously processed without waiting for an entry by the user. Thus, in step S807, since the instruction of “DECIDE N-TH DAY” is processed in a state where the place of accommodation for a target day before movement has been processed, this time, the target day is moved to the N-th day in accordance with the processing rule of (2) or (4) of FIG. 4. This processing is completely the same as that when the unnecessity of setting a place of accommodation is determined in step S801.

Accordingly, by making use of the mechanism of temporary saving and recovery of information, even when the place of accommodation has not been decided, a place of accommodation is decided, and then the target day is moved without entering any instruction again.

Turning back to FIG. 5, in step S708, the saved information is recovered when necessary. In step S709, in accordance with the processing rule, when necessary, the frame feedback unit (generation unit) 47 generates a pseudo speech frame, and feeds it back in the form of registering the frame in the speech frame queue. Different from this processing, description will be made of an example where the frame feedback unit 47 generates a pseudo speech frame independently, and feeds it back.

In each itinerary creating processing other than search or permission verification, i.e., setting of the number of tour days, target day movement, visiting order specification, existing spot deletion, and visiting time specification, after the execution of proper processing, the system outputs a certain response sentence to the user, and is placed on standby for the entry of the next instruction.

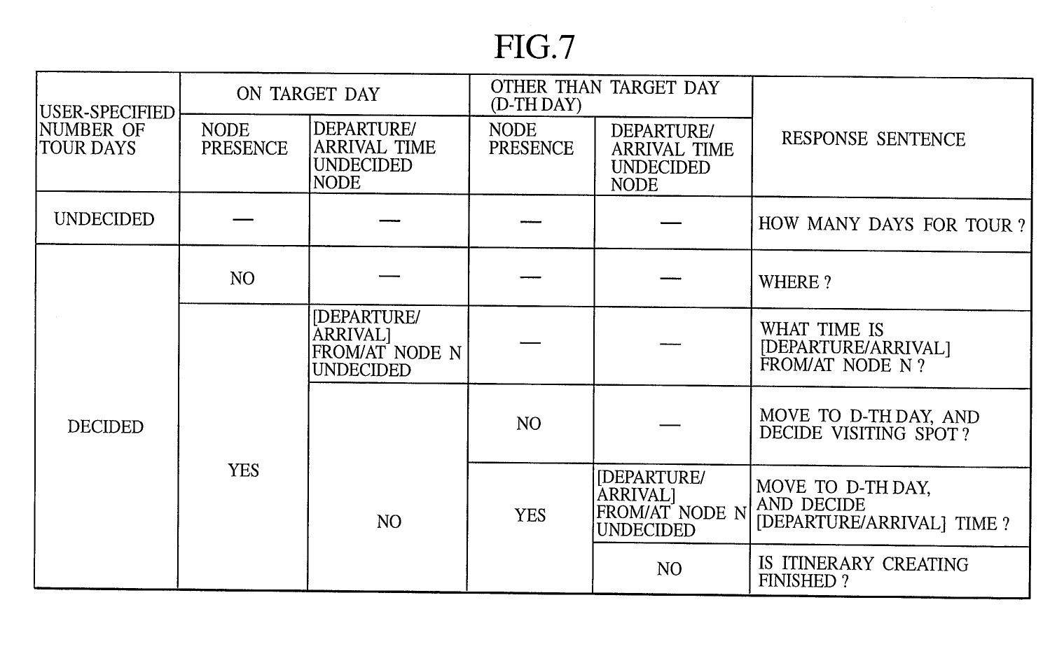

The response sentence outputted in this case is changed like those shown in FIG. 7 depending on the creating situation of an itinerary at this time. For example, if the user has not specified the number of all the days for a tour yet, the setting of the number of tour days is prompted by “HOW MANY TOUR DAYS?”. If there is a visiting spot where departure/arrival time has not been decided yet on the target day though the number of tour days has been specified, then the specification of visiting time is prompted by “WHAT TIME (DEPARTURE/ARRIVAL) FROM/AT***?”. If even time has been set for all the nodes on a target day, but there is a node where visiting time has not been decided yet for another day, then target day movement is prompted by “MOVE TO x-TH DAY, AND DECIDE (DEPARTURE/ARRIVAL) TIME FROM/AT***?”.

Such a response sentence places no limitation on a next entry by the user necessarily, and the user may enter any optional instruction irrespective of the response sentence. However, by a prompt from the system side to decide a part undecided in the itinerary, it is possible to prevent inconvenience where itinerary creating is finished in an incomplete form because of overlooking by the user.

Determination as to which of such response sentences should be generated and outputted must be made after the execution of each of the foregoing processing. For example, after the execution of setting processing of the number of tour days, a response of “HOW MANY TOUR DAYS?” must always be prevented and, after the deletion of a certain node, a call of “WHAT TIME IS ARRIVAL?” cannot be made to the node.

One possible solving means is to describe the execution of condition branching and the generation of a corresponding response sentence in all the proper processing rules. However, such means only complicates the content of the processing rules, and similar processing operations must be described overlappingly in many rules, thus considerably reducing efficiency when a system function is expanded by rewriting the processing rules.

Thus, regarding the processing rule of each itinerary creating, in addition to the original processing, only processing of “GENERATION AND FEEDBACK OF PSEUDO SPEECH FRAME” is described in common, and the generation/output processing of a response sentence corresponding to a state variable when the pseudo speech frame is entered is described as a new processing rule as shown in FIG. 7. An instruction class of the pseudo speech frame is, for example, “INTERNAL GENERATION”, and no instruction prescribed value need be provided.

Accordingly, condition determination as to response sentence selection after the execution of each itinerary creating processing is rewritten into selection determination of a processing rule when the pseudo speech frame is entered, making it possible to output a proper response sentence according to the creating situation of an itinerary at each time. Moreover, during this period, especially, it is not necessary for the user to enter any instruction.

Turning back to FIG. 5 again, in the foregoing steps S706 to S709, in accordance to the selected processing rule, processing including itinerary creating, temporarily saving and recovering of information, and generation and feeding-back of a pseudo speech frame, is executed. Then, the process returns to step S702, and the content of the speech frame queue is checked to determine if a next speech frame to be processed exists.

If it is determined in step S709 that a fed-back speech frame exists, the system continuously executes the processing of the fed-back frame without waiting for an entry from the user. By repeating the above processing, it is possible to create an itinerary according to an instruction freely made by the user.

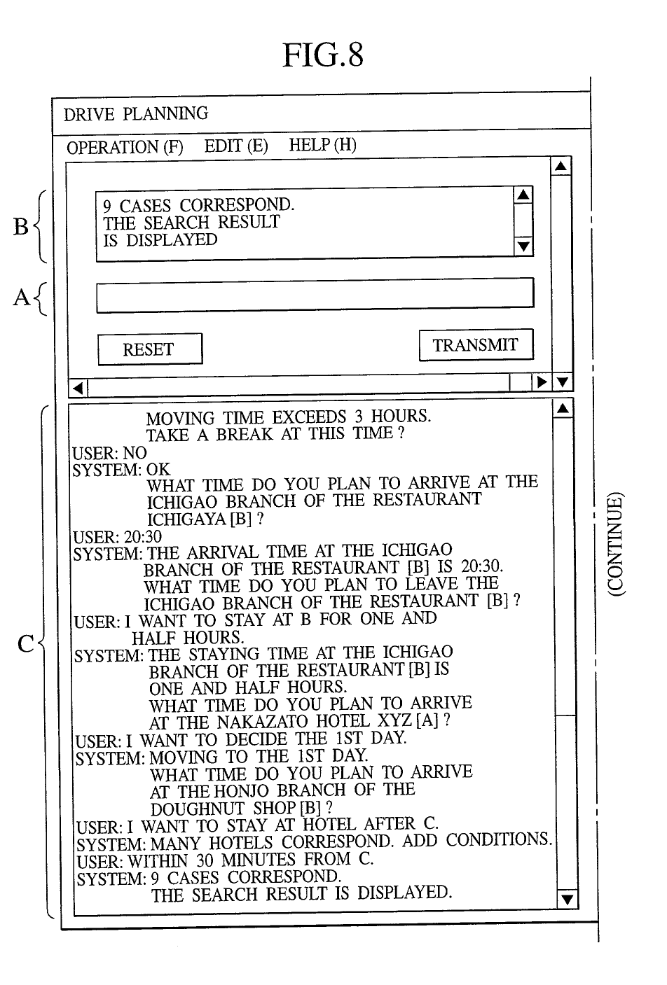

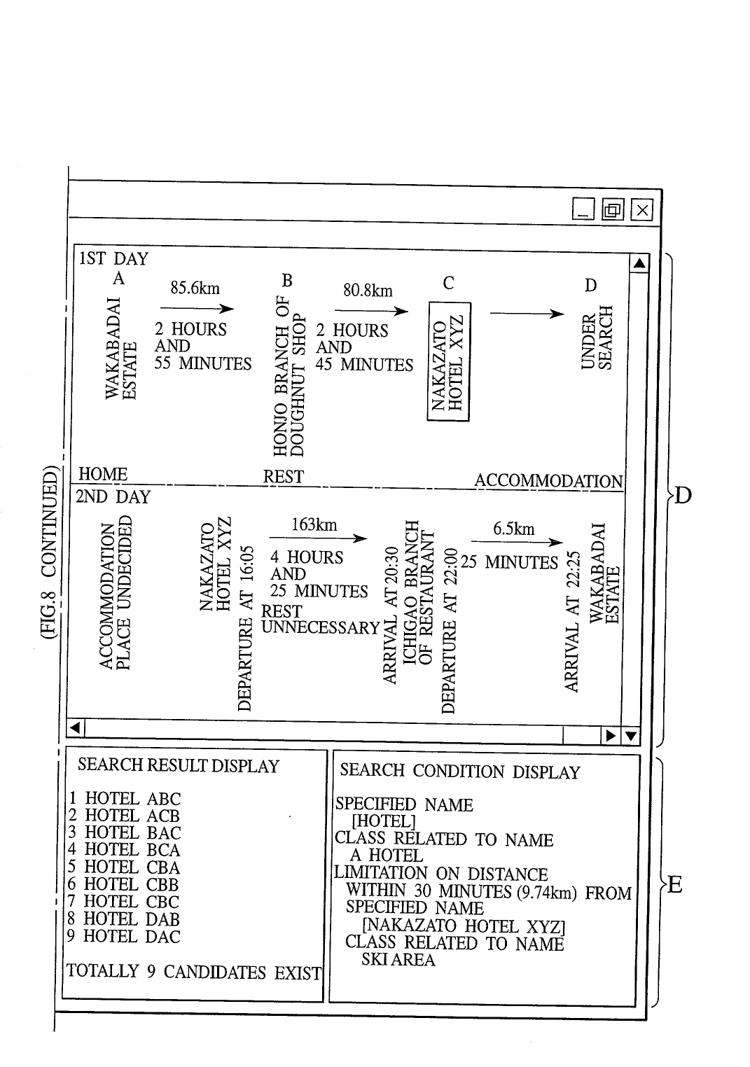

FIG. 8 shows the example of a screen display on the display device 6 by the itinerary creating service system of the present embodiment.

In this case, it is assumed that an instruction by the user is entered in a text box A of the left upper side by a keyboard as the input device 1. In a part B above the box A, a response sentence from the system is displayed in a text form. In the left lower part C, the process of interaction between the user and the system is shown. In the right upper part D, a current itinerary creating situation and a system internal state are displayed in a graphical manner. In the right lower part E, a collection of current candidate spots and search conditions entered thus far are shown regarding the search of facilities, and so on. Some buttons and menus are provided. Basically, however, only by entering an instruction to the text box A, an itinerary can be created without operating the buttons or menus.

As shown in FIG. 8, in the itinerary displaying, one of the visiting spots for a first day “NAKAZATO HOTEL XYZ” is emphasized by framing. This indicates that the visiting spot is “TARGET NODE”. The target node is a visiting spot (node) currently targeted to be default-operated by the system. For example, when the instruction of existing visiting spot deletion such as “CANCEL VISITING” or “DELETE” in this state, the target node “NAKAZATO HOTEL XYZ” is deleted.

Generally, the instruction of deletion must be uttered, e.g., “CANCEL VISIT TO HONJO BRANCH OF DOUGHNUT SHOP” by clarifying a spot to be deleted in the instruction sentence. However, when the target node is deleted, reference to the target spot can be omitted.

In addition, when the order of spots to be newly searched is specified, a speech can be provided in a form combining search condition specification and visiting order specification, for example, “STAY AT HOTEL AFTER NAKAZATO HOTEL XYZ”. In this case, spot searching is started with the “HOTEL” set as a search condition, and the insertion position of the spot under search is specified by “NEXT TO NAKAZATO HOTEL XYZ”. Accordingly, the user can set a new visiting spot in an optional position in a schedule, and especially when a new visiting spot is set after the target node, “NEXT TO . . . ” can be omitted.

There is “TARGET TIME” as a similar target. For example, when the system side outputs a response sentence of “TIME OF ARRIVAL AT HONJO BRANCH OF DOUGHNUT SHOP ?”, target time indicates “ARRIVAL TIME AT HONJO BRANCH OF DOUGHNUT SHOP”. In this case, simply by uttering “8 O'CLOCK”, time can be specified. However, in the general specification of visiting time, target time of “LEAVE HOME AT 6:30” must be clearly stated.

As described above, the instruction sentence entered by the operator is converted into a speech frame by the language analyzer 2, an itinerary is created by the central control unit 4 based on this speech frame, and visiting spots, a route between the visiting spots and a visiting day representing the created itinerary are stored respectively as a node, a link and a schedule in the state variable holding device 3. In addition, a node, a link and a schedule entered/searched in the past are also stored in the state variable holding device 3. Then, the central control unit 4 re-creates an itinerary by specifying a currently targeted node, and focusing only on a node, a link and a schedule related to the currently targeted node, stored in the state variable holding device 3. Thus, it is not necessary to remake all the schedules, and it is possible to make changes/additions to the already-created itinerary, contributing to the enhancement of convenience.

Also, control is performed in the manner that a pseudo speech frame related to the currently targeted node is generated by the frame feedback unit 47, and by feeding back the generated pseudo speech frame to the processing rule selection unit 42, an itinerary is re-created. Thus, it is possible to re-create an itinerary by focusing only on a node, a link and a schedule related to the currently targeted node.

Furthermore, if the immediate re-creating of an itinerary is not permitted, an instruction content from the operator and a system state are temporarily saved in the state variable holding device 3, and a recovery condition for recovering the temporarily saved information is stored as one of the system internal states in the state variable holding device 3. Thus, the original system state can be recovered after the re-creating of an itinerary. This arrangement enables changes/additions to be made safely to the itinerary irrespective of the system state.

### Second Embodiment

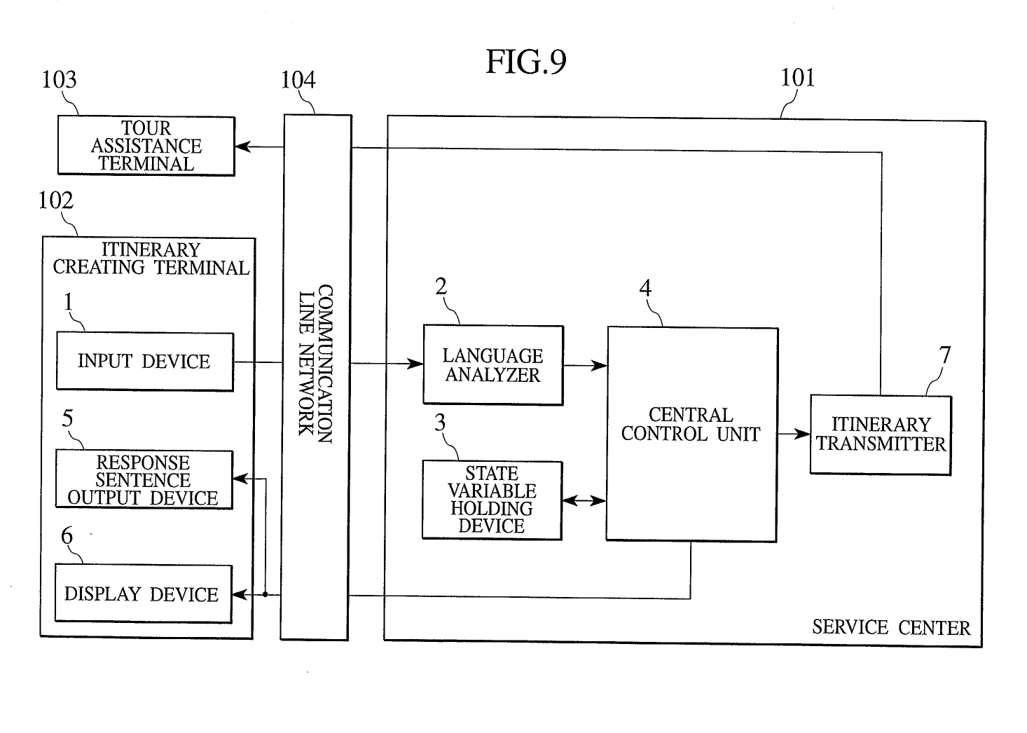

FIG. 9 shows a configuration view of an itinerary creating service system according to a second embodiment of the present invention.

First, the system configuration will be described. This system is a tour assistance service system comprising: a service center 101 for rendering services of itinerary creating, tour assistance, and so on; an itinerary creating terminal 102 for entering an instruction regarding itinerary creating by a user, or obtaining a corresponding response; and a tour assistance terminal 103 for receiving tour assistance service such as route guiding or the like when actual tour is executed in accordance with the created itinerary. These components are interconnected through a public communication line network 104.

In the configuration of the foregoing first embodiment, the input device 1, the response sentence output device 5, the display device 6, constitute the itinerary creating terminal 102, and the language analyzer 2, the state variable holding device 3, and the central control unit 4 are installed in the service center 101.

In addition, an itinerary transmitter 7 is installed in the service center 101, to transmit the created itinerary which has been recorded, when there is a request from the user. For the itinerary creating terminal 102, for example, a home-installed personal computer, a dedicated terminal or the like can be used. For the tour assistance terminal 103, for example, an on-vehicle navigation system or the like can be used. However, both terminals may be the same, for example, a mobile terminal always carried and communicable.

Itinerary creating is executed in the nearly same manner as that of the first embodiment. The created itinerary is stored with a user ID in the itinerary transmitter 7. When the user requests the transmission of the itinerary through the tour assistance terminal 103, first the user ID is verified, and an itinerary that has been created by the same user is transmitted to the tour assistance terminal 103. Thereafter, the user can execute the tour in accordance with the transmitted itinerary. In this case, the user can receive tour assistance service such as route guiding, tour advance management, and so on, according to the user's necessity. Such services may be provided independently by the tour assistance terminal 103, by cutting off communications with the service center after the itinerary transmission. Alternatively, such services may be provided directly from the center by resuming communications with the service center as occasion demands.

As described above, the service center 101 receives an instruction regarding the itinerary creating of the user from the itinerary creating terminal 102, creates an itinerary in accordance with the received instruction, and transmits the created itinerary to the tour assistance terminal 103. Thus, the user can create an itinerary not only in a vehicle, but also, for example, through the home-installed terminal, by simple interaction, and this itinerary can be used in the vehicle during driving. In addition, by installing a database regarding visiting facilities or the like necessary for itinerary creating in the center, a large-scale database difficult to be updated/managed individually can be utilized to make it possible to create an itinerary based on abundant new information.

The tour assistance terminal 103 may be united with the itinerary creating terminal 102 and loaded in the vehicle. In this case, the service center 101 receives an instruction sentence entered by the operator from the itinerary creating terminal 102, and converts the received instruction sentence into a speech frame. The central control unit 4 creates an itinerary based on the speech frame. Visiting spots, a route between the visiting spots and a visiting day representing the created itinerary are stored respectively as a node, a link and a schedule in the state variable holding device 3, and also a node, a link and a schedule entered/searched in the past are stored in the state variable holding device 3. Then, the central control unit 4 re-creates an itinerary by specifying a currently targeted node, and focusing only on a node, a link and a schedule related to the stored and currently targeted node, and transmits the created itinerary to the itinerary creating terminal 102 (operator-side terminal). Thus, without any need to remake all the schedules, by making changes/additions to the already-created itinerary, the service center can transmit the itinerary again to the operator-side terminal, contributing to the enhancement of convenience at the operator-side terminal.

In addition, control is performed in the manner that a pseudo speech frame related to the currently targeted node is generated by the frame feedback unit 47, and an itinerary is re-created by feeding back the generated pseudo speech frame to the processing rule selection unit 42. Thus, it is possible to re-create an itinerary by focusing only on a node, a link and a schedule related to the currently targeted node.

Furthermore, when the immediate execution of itinerary recreating is not permitted, the instruction content from the operator and the system state are temporarily saved in the state variable holding device 3, and the recovery condition for recovering the temporarily saved information is stored as one of the system internal states in the stage variable holding device 3. Thus, the original system state can be recovered after the re-creating of the itinerary, making it possible to safely make changes/additions to the itinerary irrespective of the system state.

As apparent from the foregoing description, according to the present invention, by making use of the itinerary creating service system, it is possible to advance itinerary creating work efficiently and quickly in a natural interactive manner like between humans, and by a highly free planning approach having no procedure problem, and thus a work burden on the user can be considerably reduced. Moreover, by eliminating constraints on hardware, e.g., by using a voice recognition device for the input device, even a general user can easily enter an instruction. Thus, it is possible to create an itinerary even in the vehicle, and immediately start a tour.

The contents of Japanese Patent Application No. 2000-345488, filed on Nov. 13, 2000 is expressly incorporated herein by reference in its entirety.

What is claimed is:

1. An itinerary creating apparatus comprising:
a language analyzer configured to convert an instruction sentence entered by an operator into a speech frame;
an itinerary creating device configured to creat an itinerary based on the speech frame obtained by the conversion of the instruction sentence executed by said language analyzer;
an itinerary storage unit configured to store visiting spots, a route between the visiting spots, and a visiting day representing the itinerary created by said itinerary creating device respectively as a node, a link and a schedule, and also storing a node, a link and a schedule respectively entered/searched in the past;
a node specification unit configured to specify a currently targeted node; and
an itinerary re-creating device configured to re-create an itinerary by focusing only on a node, a link and a schedule related to the currently targeted node stored in said itinerary storage unit.

2. An itinerary creating apparatus according to claim 1, wherein said itinerary re-creating device includes a generation unit configured to generate a pseudo speech frame related to said currently targeted node, and a control unit configured to perform control to re-create an itinerary by feeding back the generated pseudo speech frame to said itinerary creating device.

3. An itinerary creating apparatus according to claim 1, wherein said control unit includes a saved information holding unit configured to temporarily save an instruction content from the operator and a system state when said immediate re-creating of the itinerary is impossible, and stores a recovery condition configured to recover the temporarily saved information as one of system internal states in said itinerary storage unit.

4. An itinerary creating service system comprising:
an operator-side terminal configured to enter/output information with an operator; and
a service center configured to create an itinerary, connected to said operator-side terminal through a communication line,
wherein said service center includes a language analyzer configured to convert an instruction sentence entered by the operator from said operator side terminal into a speech frame, an itinerary creating device configured to create an itinerary based on the speech frame obtained by the conversion of the instruction sentence by the language analyzer, an itinerary storage unit configured to store visiting spots, a route between the visiting spots, and a visiting day representing the itinerary created by the itinerary creating device respectively as a node, a link and a schedule, and also storing a node, a link and a schedule entered/searched in the past, a node specification unit configured to specify a currently targeted node, an itinerary re-creating device configured to re-create an itinerary by focusing only on a node, a link and a schedule related to the currently targeted node stored in said itinerary storage unit, and a transmitter configured to transmit the re-created itinerary to said operator-side terminal.

5. An itinerary creating service system according to claim 4, wherein the itinerary re-creating device includes a generation unit configured to generate a pseudo speech frame related to the currently targeted node, and a control unit configured to perform control to re-create an itinerary by feeding back the generated pseudo speech frame to said itinerary creating device.

6. An itinerary creating service system according to claim 4, wherein said control unit includes a saved information holding unit configured to temporarily save an instruction content from the operator and a system state when said creating of the itinerary is impossible, and stores a recovery condition configured to recover the temporarily saved information as one of system internal states in the itinerary storage unit.

7. An itinerary creating service system comprising:
an itinerary creating terminal configured to enter/output information with an operator;
a service center configured to create an itinerary and rendering a service of tour assistance;
a tour assistance terminal loaded on a vehicle to assist a tour; and
a communication line configured to interconnect said itinerary creating terminal, said service center and said tour assistance terminal,
wherein said service center includes an itinerary creating apparatus, the itinerary creating apparatus including a language analyzer configured to convert an instruction sentence entered by the operator into a speech frame, an itinerary creating device configured to create an itinerary based on the speech frame obtained by the conversion of the instruction sentence by said language analyzer, an itinerary storage unit configured to store visiting spots, a route between the visiting spots, and a visiting day representing the itinerary created by said itinerary creating device respectively as a node, a link and a schedule, and also storing a node, a link and a schedule entered/searched in the past, a node specification unit configured to specify a currently targeted node, and an itinerary re-creating device configured to re-create an itinerary by focusing only on a node, a link and a schedule related to the currently targeted node stored in said itinerary storage unit, and
wherein said itinerary creating device receives an instruction as to the itinerary creating by the operator from said itinerary creating terminal, creates an itinerary according to the received instruction, and transmits the created itinerary to said tour assistance terminal.

8. An itinerary creating method comprising the steps of:
converting an instruction sentence entered by an operator into a speech frame by a language analyzer;
creating an itinerary by an itinerary creating device based on the speech frame;
storing visiting spots, a route between the visiting spots and a visiting day representing the created itinerary respectively as a node, a link and a schedule, and also storing a node, a link and a schedule entered/searched in the past in an itinerary storage unit;
specifying a currently targeted node by a node specification unit; and
re-creating an itinerary by an itinerary re-creating device by focusing only on a node, a link and a schedule related to the currently targeted node stored in the itinerary storage unit.

9. An itinerary creating method according to claim 8, wherein in said itinerary re-creating step, a generation unit generates a pseudo speech frame related to said currently targeted node, and a control unit performs control to re-create an itinerary by feeding back the generated pseudo speech frame to said itinerary creating device.

10. An itinerary creating apparatus comprising:
language analyzing means for converting an instruction sentence entered by an operator into a speech frame;
itinerary creating means for creating an itinerary based on the speech frame obtained by the conversion of the instruction sentence executed by said language analyzing means;
itinerary storage means for storing visiting spots, a route between the visiting spots, and a visiting day representing the itinerary created by said itinerary creating means respectively as a node, a link and a schedule, and also storing a node, a link and a schedule respectively entered/searched in the past;
node specification means for specifying a currently targeted node; and
itinerary re-creating means for re-creating an itinerary by focusing only on a node, a link and a schedule related to the currently targeted node stored in said itinerary storage unit.
